(19) United States
(12) Patent Application Publication
(10) Pub. No.: US 2021/0319074 A1
(43) Pub. Date: Oct. 14, 2021

(54) METHOD AND SYSTEM FOR PROVIDING TRENDING SEARCH TERMS

(71) Applicant: NAVER CORPORATION, Gyeonggi-do (KR)

(72) Inventors: Yuwon KIM, Seongnam-si (KR); Gwang Lim GHIM, Seongnam-si (KR)

(73) Assignee: NAVER CORPORATION, Gyeonggi-do (KR)

(21) Appl. No.: 17/113,421

(22) Filed: Dec. 7, 2020

(30) Foreign Application Priority Data
Apr. 13, 2020 (KR) 10-2020-0044901

(51) Int. Cl. G06F 16/9538; G06F 16/9536; G06F 16/906

(52) U.S. Cl. CPC G06F 16/9538; G06F 16/906; G06F 16/9536

(57) ABSTRACT

Methods and systems for providing trending search terms are provided. The method includes determining first search ranking values of one or more search terms based on a number of inputs of the one or more search terms input from a plurality of first user terminals, receiving weights of a plurality of categories from a second user terminal, determining correlations of the plurality of categories with the one or more search terms, determining second search ranking values of the one or more search terms by applying the weights of the plurality of categories to the correlations of the plurality of categories with the one or more search terms, and determining final search ranking values of each of the one or more search terms based on the first search ranking values and the second search ranking values.

### CROSS-REFERENCE TO RELATED APPLICATION

This application claims priority under 35 U.S.C § 119 to Korean Patent Application No. 10-2020-0044901, filed in the Korean Intellectual Property Office on Apr. 13, 2020, the entire contents of which are hereby incorporated by reference.

### BACKGROUND

### Technical Field

The present disclosure relates to methods and/or systems for providing trending search terms, and more specifically, to methods and/or systems for providing search rankings of the trending search terms, which are determined based on the number of inputs of the search terms by a plurality of users and a category preference or weight of a specific user.

### Description of the Related Art

With the proliferation of mobile devices such as smartphones and the development of the Internet, users are enabled to access various contents in their everyday lives by entering search terms in an application having a search function such as a web browser to quickly and easily obtain a desired search result. In addition, users can check a number of interests and current issues by receiving a list of search terms according to search rankings of search terms recently input by a number of users through the web browser or the like.

Meanwhile, when passively receiving a list of search terms according to the search ranking, the users tend to reselect top ranking search terms in the provided list of search terms and input the reselected terms. These selections and inputs of the top search terms can be fed back to a search engine, further reinforcing the search ranking of the selected and input search terms compared to the actual popularity or importance of the corresponding search term.

In addition, the related method for providing search rankings simply provides the ranking result based on the number of inputs of search terms recently input by a plurality of users. Therefore, the users remain passive as they are provided with information on the top search rankings that do not reflect users' actual interests in a specific issue or importance thereof.

Meanwhile, in the related method for providing search rankings, a number of similar or related search terms related to events or issues that are of recent interests to a large number of users may occupy the top of the search rankings. In this case, a phenomenon may occur, in which the search ranking of search terms related to the corresponding event or issue are further reinforced. Thus, it is difficult that the users are provided with information on search terms related to issues other than the currently top-searched issues, or search terms related to individual users' interests.

### SUMMARY

The present disclosure has been made to overcome the problems mentioned above, and it is an object of the present disclosure to provide a method and system for providing trending search term rankings, which are determined based on the number of inputs of the search terms by a plurality of users and a category preference or weight of a specific user.

The present disclosure provides methods and/or systems for providing trending search terms, which can reflect a search category preference or interest of a specific user, when providing ranking information of the search terms related to events, issues, incidents, people, and so on, that are of recent interests to a large number of users.

Further, the present disclosure provides methods and/or systems for providing trending search terms, which generate groups of similar or related search terms according to weights of grouping as set by the user, and provides a group search rankings of the search term groups, such that search terms related to various issues can be included in the search ranking list.

The present disclosure may be implemented in a variety of ways, including a method, a system, a device, or a non-transitory computer-readable storage medium including a computer program.

According to an example embodiment, a method for providing trending search terms performed by at least one processor of a computer system may include determining first search ranking values of one or more search terms based on a number of inputs of the one or more search terms input from a plurality of first user terminals, receiving weights of a plurality of categories from a second user terminal, determining correlations of the plurality of categories with the one or more search terms, determining second search ranking values of the one or more search terms by applying the weights of the plurality of categories to the correlations of the plurality of categories with the one or more search terms, and determining final search ranking values of each of the one or more search terms based on the first search ranking values and the second search ranking values.

According to another example embodiment, a method for providing trending search terms performed by at least one processor of a computer system may include receiving first search ranking values of one or more search terms determined based on a number of inputs of the one or more search terms input from a plurality of user terminals, receiving, by a first user interface, weights of a plurality of categories, determining second search ranking values of the one or more search terms by applying the weights of the plurality of categories to correlations of the plurality of categories with the one or more search terms, determining final search ranking values of each of the one or more search terms based on the first search ranking values and the second search ranking values, and displaying, by a second user interface, at least some of the one or more search terms according to the final search ranking values.

According to still another example embodiment of the present disclosure, there is provided a non-transitory computer-readable recording medium storing instructions for executing, on a computer, the method for providing trending search terms described above.

According to still another example embodiment of the present disclosure, a system for providing trending search terms may include a memory and at least one processor connected to the memory and configured to execute computer-readable commands stored in the memory. The at least one processor may be configured to receive one or more search terms from a plurality of user terminals and receive weights of a plurality of categories from a second user, determine first search ranking values of the one or more search terms based on a number of inputs of the one or more search terms, determine correlations of the plurality of categories with the one or more search terms, determine second search ranking values of the one or more search terms by applying the weights of the plurality of categories to the correlations of the plurality of categories with the one or more search terms, and determine final search ranking values of each of the one or more search terms based on the first search ranking values and the second search ranking values.

According to some example embodiments of the present disclosure, a service for providing trending search terms may provide an environment, in which a user can set interest or preference information for a specific search term category. Accordingly, in providing the trending search term ranking, the trending search terms list reflecting the user's individual interest or importance to a specific issue can be provided, instead of simply providing the user with the information on the trending search ranking based on the number of searches.

According to some example embodiments of the present disclosure, in a service for providing trending search terms, the user may be able to set a reference similarity that can be used to group the similar or related search terms. Accordingly, by grouping similar search terms into one group according to the reference similarity set by the user, when similar or related search terms are ranked high, the ranking information of the search terms that would not be provided otherwise can be provided to the user. Accordingly, the user may be provided with the ranking information of search terms related to more various issues when using the service for providing trending search terms.

According to some example embodiments of the present disclosure, when using the service for providing trending search terms, it is possible to solve a problem that implicit feedback is applied to the search engine by reselecting and inputting of the top search terms by the users. Further, the user may provide information on preference or interest on a specific issue to the trending search term service as the explicit feedback and receive search ranking information reflecting the information.

### BRIEF DESCRIPTION OF THE DRAWINGS

Some example embodiments of the present disclosure will be described with reference to the accompanying drawings described below, where similar reference numerals indicate similar components, but are not limited thereto, in which:

FIG. 1 illustrates an example of a user interface of a user terminal displaying trending search term rankings by a method for providing trending search terms according to an example embodiment;

FIG. 2 illustrates an example of a user interface of a user terminal displaying trending search term rankings by a method for providing trending search terms according to another example embodiment of the present disclosure;

FIG. 3 is an example diagram showing trending search term rankings determined by setting weights of a plurality of categories and weight of the grouping in a search term setting interface according to an example embodiment;

FIG. 4 is a schematic diagram illustrating a system communicatively connecting a plurality of user terminals to a server over a network for providing trending search terms in order to provide a trending search term service according to an example embodiment;

FIG. 5 is a block diagram illustrating an internal configuration of a user terminal and of a server for providing trending search terms according to an example embodiment;

FIG. 6 is a block diagram illustrating an internal configuration of a processor of a server for providing trending search terms according to an example embodiment;

FIG. 7 is a flowchart illustrating a method for determining a final search ranking value of a search term, which is performed by a server for providing trending search terms according to an example embodiment;

FIG. 8 is a flowchart illustrating a method for determining a group search ranking value, which is performed by a server for providing trending search terms according to an example embodiment;

FIG. 9 is a flowchart illustrating a method for determining a final search ranking value of a search term, which is performed by a user terminal according to an example embodiment;

FIG. 10 is a flowchart illustrating a method for determining a group search ranking value, which is performed by a user terminal according to an example embodiment;

FIGS. 11A to 11C are example diagrams showing an operation of inputting weights of a plurality of categories according to an example embodiment;

FIGS. 12A to 12C are example diagrams showing an operation of inputting a weight of the grouping according to an example embodiment;

FIG. 13 is an example diagram showing an operation in which at least some of search terms included in one or more groups are displayed by a user interface or search ranking list according to a group search ranking value according to an example embodiment;

FIG. 14 is an example diagram showing an operation in which search terms are output according to a final search ranking value determined based on input weights of a plurality of categories according to an example embodiment; and

FIG. 15 is an example diagram showing an operation in which search terms are output according to a group search ranking value determined based on the input weight of the grouping according to an example embodiment.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding components are given the same reference numerals. In addition, in the following description of the example embodiments, duplicate descriptions of the same or corresponding components may be omitted. However, even if descriptions of components are omitted, it is not intended that such components are not included in any example embodiment.

Advantages and features of example embodiments will be apparent by referring to the disclosed example embodiments described below in connection with the accompanying drawings. However, the present disclosure is not limited to the disclosed example embodiments disclosed below, and may be implemented in various different forms, and the present example embodiments are merely provided to make the present disclosure complete, and to fully disclose the scope of the present disclosure to those skilled in the art to which the present disclosure pertains.

The terms used herein will be briefly described prior to describing the disclosed example embodiments in detail. The terms used herein have been selected as general terms, which are widely used at present in consideration of the functions of the present disclosure, and this may be altered according to the intent of an operator skilled in the art, conventional practice, or introduction of new technology. In addition, in a specific case, a term is arbitrarily selected by the applicant, and the meaning of the term will be described in detail in a corresponding description of the example embodiments. Therefore, the terms used in the present disclosure should be defined based on the meaning of the terms and the overall contents of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms.

Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to execute at least one processor. Accordingly, as an example, the “module” or “unit” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

According to an example embodiment of the present disclosure, the “module” or “unit” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and so forth. Under some circumstances, a “processor” may refer to an application-specific integrated circuit (ASIC), a programmable logic device (PLD), a field-programmable gate array (FPGA), and so on. The term “processor” may refer to a combination of processing devices (e.g., a combination of a DSP and a microprocessor), a plurality of microprocessors, one or more microprocessors in conjunction with a DSP core, or any other combination of such configurations. In addition, the term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory that is integral to a processor is in electronic communication with the processor.

As used herein, the “search term” may include a text (e.g., words, phrases, or sentences) that can be input and searched through a search engine, but is not limited thereto. For example, the search term may include a text entered by a user through an input UI of a search program such as a web browser or a search application, or may include a text that may be selected by a user by clicking on any one search term from among the search terms included in the search term list provided by the search program. In another example, the search term is not limited to the text, and may include a text or information that may be extracted from multimedia content such as images, videos, voices, sounds, and so on.

As used herein, the “trending search term” may refer to a search term whose number of inputs recently increased or is currently increased number of inputs rapidly compared to the general or average number of inputs of the search term. In addition, the “real-time trending search term” may mean a search term whose number of inputs calculated in real time rapidly increases. For example, the trending search term may be determined according to a degree of an increase in the number of inputs measured in real-time or based on a specific time period (e.g., 30 minutes, 2 hours, or 24 hours).

As used herein, “category” may refer to a classification of search terms determined according to meanings, events, issues, and so on as indicated by the search terms. For example, the categories of search terms may include “Current Affairs”, “Discount Info”, “Sports”, “Entertainment”, and so on, but are not limited thereto, and may be changed, expanded or reduced according to a change in the number, type, variety, or meaning of the search terms input by users.

As used herein, “group” may refer to a set of search terms classified based on similarity or correlation. For example, a group of search terms may be determined based on the meanings of search terms or similarity of categories, and according to these criteria, search terms may be formed into one or more groups by “grouping”. In this regard, “representative search term” may mean a search term that ranks highest among the search terms included in each group generated by grouping of the search terms. Meanwhile, “rest search term” may mean the other search terms included in the group generated by grouping except the “representative search term”.

As used herein, “weight” may indicate preference, interest, or importance that a user may respectively assign to a search term, a category of search terms, or a group of search terms. The user may set a higher weight for a specific search term, category, or group over other search terms, categories, or groups, and thus can obtain more information about the search term, category or group with a higher weight. For example, when the user assigns a higher weight to the “Current Affairs” category than to the “Entertainment” category, it may mean that the user is more interested in the search term (e.g., “social issue” or “incident or accident information”) related to the “Current Affairs” category than in the search term (e.g., “celebrity information”, “movie information”, or “game information”) related to the “entertainment” category. In addition, the weight of the group or grouping may be used to determine a reference similarity used to generate a group of search terms. For example, as the “weight of the grouping” is higher, a lower reference similarity may be set, so that a larger number of similar or related search terms may be included in one group. On the other hand, when the “weight of the grouping” is lower, a higher reference similarity may be set, so that a smaller number of similar or related search terms may be included in one group. That is, the search terms classified into different groups based on a certain grouping weight may be grouped into the same group when the weight of the grouping is increased.

As used herein, “category correlation” may mean a degree or probability that a specific search term will be included in or related with a specific category. For example, a search term indicating the name of a specific entertainer may have a high correlation with the “entertainment” category. In addition, the category correlation may be determined by embedding search terms related to a plurality of categories in a vector space and calculating a probability value that each search term will be classified to a specific category. As used herein, “embedding” may refer to a technique for converting a categorical or discrete variable into a continuous vector. The embedding may be used to reduce the dimension of information and derive meaning by converting categorical variables such as search terms into continuous vectors. In addition, when a keyword is expressed as a vector in the embedding vector space, vectors close to each other in the vector space may share similar or related characteristics. For example, a method for embedding search terms into a vector space may be implemented through learning of an artificial neural network.

As used herein, “content” may represent various types of information that can be searched according to an input of a search term. For example, the content includes news, homepages, blog posts, or internet cafe posts that includes various information such as texts, images, videos, and so on, but is not limited thereto.

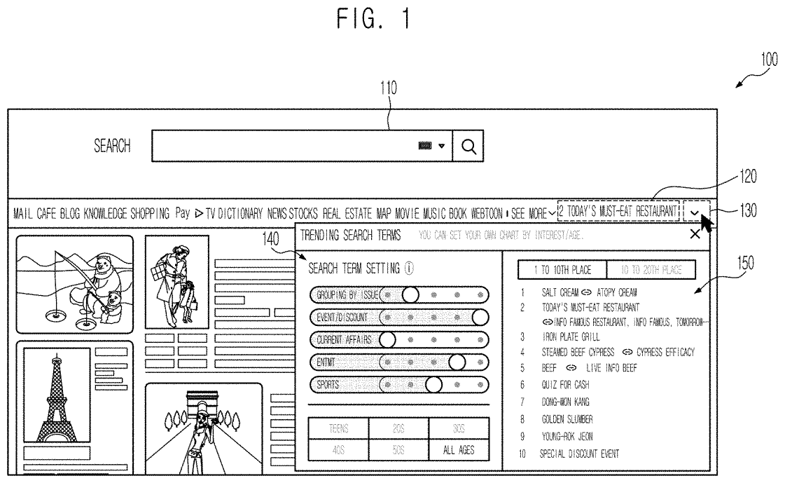

FIG. 1 illustrates an example of a user interface of a user terminal displaying trending search term rankings by a method for providing trending search terms according to an example embodiment.

The user interface 100 illustrated in FIG. 1 shows a state in which a user runs a web browser on a user terminal (e.g., a desktop computer, or a tablet computer) to access a web page of a portal site that provides a search service. The user may perform a search by inputting a search term into a search term input portion 110 located at an upper portion of the web page of the portal site displayed on the web browser.

Meanwhile, at least one of the trending search terms may be output on a portion of the web page of the portal site displayed on the web browser. In the example illustrated in FIG. 1, at a lower portion of the search term input portion 110 displayed on the web page of the portal site, a menu bar for selecting various services (e.g., mail, cafe, or blog) provided by the portal site is displayed. In addition, at a location adjacent to the menu bar on the web page of the portal site, a search term “Today's must-eat restaurant” 120, which corresponds to the second highest rank in the search ranking among the trending search terms, is output along with its corresponding rank.

In addition, the user may select a button 130 to check more detailed information on the ranking of the trending search terms on the website of the portal site. As the user selects the button 130, a pop-up window including a search term setting interface 140 and a trending search term ranking list 150 may be displayed.

As illustrated, in the search term setting interface 140, a “Group by Issue” slide bar for setting the weight of the grouping of search terms may be displayed. The user may set the weight of the grouping as desired by himself/herself, by moving the “Group by Issue” slide bar. For example, by moving the “Group by Issue” slide bar to the right side of the screen, a higher weight of the grouping may be set, and accordingly, the number of the representative search terms and the rest search terms of each ranking displayed in the trending search term ranking list 150 may be increased. On the other hand, by moving the “Group by Issue” slide bar to the left side of the screen, a lower weight of the grouping may be set, and accordingly, the number of the representative search terms and the rest search terms of each ranking displayed in the trending search term ranking list 150 may be reduced.

In addition, in the search term setting interface 140, one or more slide bars for setting a weight of each search term category may be displayed. As illustrated, the search term setting interface 140 may include slide bars for setting weights of an “Event*Discount” category, a “Current Affairs” category, an “ENTMT (entertainment)” category, and a “Sports” category. The user may set the weight of each category by moving one or more of the slide bars of the category weight. For example, the user may move the slide bar of the “Current Affairs” category weight to the right side of the screen, so that more search terms related to the current affairs issue are displayed in the trending search term ranking list 150. In another example, the user may move the slide bar of the “ENTMT” category weight to the left side of the screen, so that fewer search terms related to the entertainment (e.g., entertainment industry) issue are displayed in the trending search term ranking list 150.

The example illustrated in FIG. 1 shows that the weight of search term grouping and the weight of each search term category are set by moving the slide bar in the search term setting interface 140, but the present disclosure is not limited thereto. For example, in the search term setting interface 140, the weight of the search term grouping and the weight of each search term category may be set using any one of various user interfaces, such as with a method of selecting (e.g., clicking or touching) a desired weight from a “drop-down list”, a method of selecting (clicking) a desired weight from among the items listed in a “combo box”, a method of selecting and adjusting an arrow button in “spinner” or inputting the weight directly in the edit field, a method of inputting the weight in the “text input field”, a method of selecting whether or not to apply one or more weights in a “checkbox”, and so on.

According to an example embodiment, in the search term setting interface 140, one or more dropboxes for setting weight of the grouping of search terms and weight of each search term category may be displayed. The user may click some of the dropboxes to check selectable items, and may select some of the selectable items to set a weight of the grouping of search term and a weight of each search term category. For example, in the search term setting interface 140, the user may set a low weight of the grouping by selecting a “low” item among the “high”, “middle”, and “low” items that appear upon clicking a part of the dropbox for setting the weights of the search term groupings.

According to another example embodiment, in the search term setting interface 140, one or more checkboxes for setting whether or not to apply the weight of the search term grouping and the weight of each search term category may be displayed. The user may set whether or not to apply the grouping weight and the weight of each search term category, respectively, by selecting some of the checkboxes that indicate whether to apply the weight of the grouping and the weight of each search term category. For example, an “Event*Discount” category, a “Current Affairs” category, an “ENTMT (entertainment)” category, and a “Sports” category may be displayed as the checkboxes selectable by the user in the search term setting interface 140. Here, the user may select the checkboxes of the “Current Affairs” category and the “Sports” category such that a desired (or alternatively, predetermined) weight may be applied to the “Current Affairs” category and the “Sports” category, while the weight is not applied to the “Event*Discount” category and “ENTMT (entertainment)” category.

As illustrated in FIG. 1, the user may select or adjust various options (e.g., search term grouping weight, and/or search term category weight) for determining the trending search term ranking according to his/her preference or interest, through the search term setting interface 140 displayed on the screen of the user terminal. Accordingly, the trending search term ranking list 150 may include more of the search terms that correspond to a category desired by the user, in the trending search ranking.

The example illustrated in FIG. 1 shows that the method for providing trending search terms of the present disclosure is provided in a search service of a portal site displayed on a web browser executed by a user terminal, but the present disclosure is not limited thereto. In some example embodiments, this method may be provided in a search application executed by the user terminal.

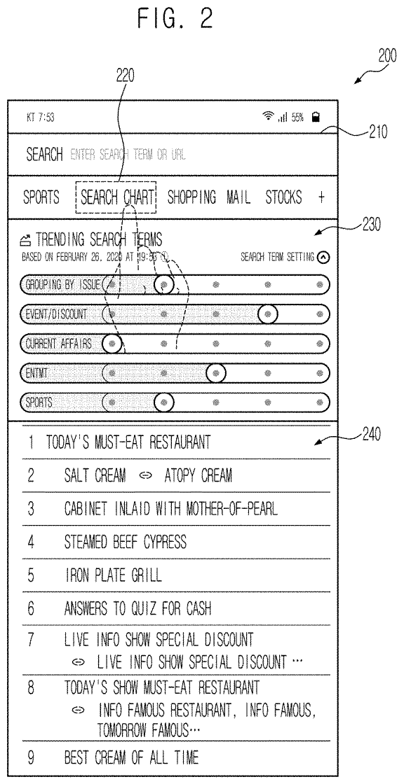

FIG. 2 illustrates an example of a user interface of a user terminal displaying trending search term rankings by a method for providing trending search terms according to another example embodiment of the present disclosure.

The user interface 200 illustrated in FIG. 2 shows an example in which a user executes a search application on a user terminal (e.g., a smartphone) to use a search service. The user may perform a search by inputting a search term into a search term input portion 210 located at an upper portion of the application screen.

When the user selects a “Search Chart” menu 220, a search term setting interface 230 and a trending search term ranking list 240 may be displayed at a lower portion of the menu 220. Similarly to the example described with reference to FIG. 1, the search term setting interface 230 may include a “Group By Issue” slide bar for setting a weight of the search term grouping, and slide bars for setting weights of the “Event*Discount”, “Current Affairs”, “ENTMT”, and “Sports” categories. Further, in the lower portion of the search term setting interface 230, the trending search term ranking list 240 determined according to a search term grouping weight and a weight of each category set by a user in the search term setting interface 230 is displayed. For example, in the trending search term ranking list 240, representative search terms (“today's must-eat restaurant”, “salt cream”, and so on) ranked from 1st to 9th may be arranged together with remaining search terms (“atopy cream”, “live info show beef intestine soup”, and so on) grouped in relation to the representative search terms.

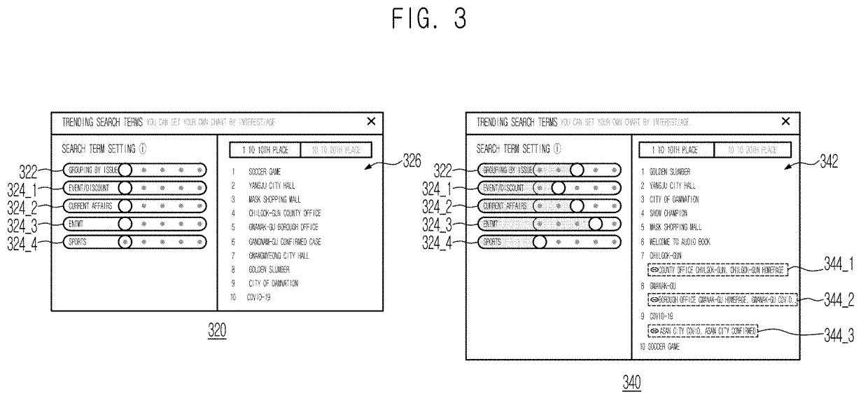

FIG. 3 is an example diagram showing trending search term rankings determined by setting weights of a plurality of categories and weight of the grouping in a search term setting interface according to an example embodiment.

As illustrated, by changing the weight of the search term grouping and the weight of each category through the search term setting interface displayed on the screens 320 and 340 of the user terminal, the search term ranking displayed in the trending search term ranking list and the search term corresponding to each ranking may be changed.

For example, when a “Group by Issue” slide bar 322 on the screen 320 representing the grouping weight is moved to the leftmost side, the grouping weight is set to a minimum value (e.g., level 1). Accordingly, only one search term (e.g., a representative search term) is displayed in each ranking displayed in the trending search term ranking list 326. On the other hand, as displayed on the screen 340, when the “Group By Issue” slide bar 322 is set to level 3, one or more of the rest search terms related to the representative search term may also be displayed in each ranking of the trending search term ranking list 342. For example, in the trending search term ranking list 342, in addition to the representative search term “Chilgok-gun County Office” ranked 7th, the rest search terms included in the same group, which are, “Chilgok-gun” and “Chilgok-gun homepage” 344_1, are also displayed. Further, the trending search term ranking list 342 shows, in the group including the representative search term “Gwanak-gu Borough Office” ranked 8th, the search terms 344_2 of “Gwanak-gu homepage” and so on, and shows, in the group including the representative search term “COVID-19” ranked 9th, the search terms 344_3 of “Asan COVID” and so on that are displayed together by grouping.

Further, when all slide bars of a plurality of categories on the screen 320 are set to the leftmost sides (i.e., level 1), the trending search term ranking list 326 shows “1st—Soccer Game, 2nd—Yangju City Hall, 3rd—Mask shopping mall”, and so on. On the other hand, on the screen 340, when setting the slide bar of “Event*Discount” category to level 2, the slide bar of “Current Affairs” category to level 3, the slide bar of “ENTMT” category to level 4, and the slide bar of “Sports” category to level 1, the trending search term ranking list 342 displays “1st—Golden slumber, 2nd—Yangju City Hall, 3rd—City of Damnation, and so on”. That is, the ranking of “soccer game”, which was ranked 1st in the trending search term ranking list 326 of the screen 320, is changed and now ranked 10th in the trending search term ranking list 342 of the screen 340. Further, a search term, “Welcome to audio book,” which was not displayed in the trending search term ranking list 326 of the screen 320, is now ranked 6th in the trending search term ranking list 342 of the screen 340. In this way, the ranking and the search terms displayed in the trending search term ranking list are changed by changing the category weights set at the same level in the search term setting interface of the screen 320 to different levels in the search term setting interface of the screen 340. That is, in the search term setting interface of the screen 340, because the weight of the “ENTMT” category is set to a relatively high level, the ranking of the related search terms may be increased, and, since the weight of the “Sports” category is set to a relatively low level, the ranking of the related search terms may be decreased.

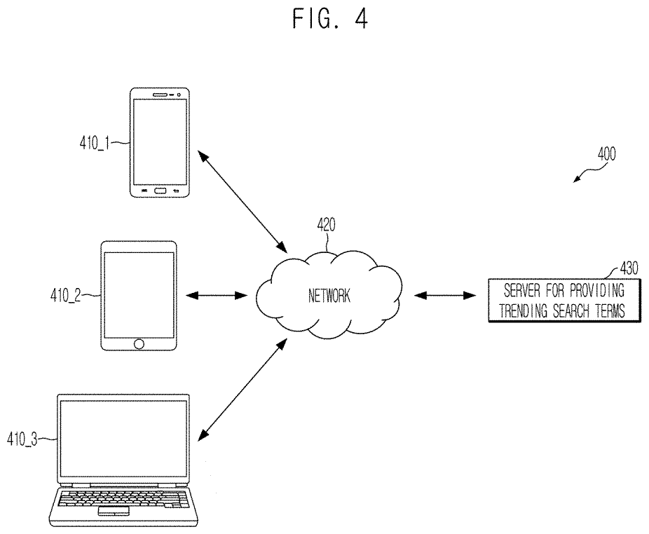

FIG. 4 is a schematic diagram illustrating a system 400 communicatively connecting a plurality of user terminals 410_1, 410_2, and 410_3 to a server 430 over a network 420 for providing trending search terms in order to provide a trending search term service according to an example embodiment.

As illustrated, the system 400 may include a server 430 for providing trending search terms, which provides a search engine service including a service for providing trending search terms, and a plurality of user terminals 410_1, 410_2, and 410_3 connected to the server 430 for providing trending search terms through a network 420. According to an example embodiment, the server 430 for providing trending search terms may include one or more server devices and/or databases, or one or more distributed computing devices and/or distributed databases based on cloud computing services that can store, provide and execute a computer executable program (e.g., a downloadable application) and data for providing a search engine service. The search engine service provided by the server 430 for providing trending search terms may be provided to a user through a search application or a web browser installed in each of the plurality of user terminals 410_1, 410_2, and 410_3.

The plurality of user terminals 410_1, 410_2, and 410_3 may communicate with the server 430 for providing trending search terms through the network 420. The network 420 may be configured to enable communication between the plurality of user terminals 410 and the server 430 for providing trending search terms. The network 420 may be configured as a wired network 420 such as Ethernet, a wired home network (Power Line Communication), a telephone line communication device and RS-serial communication, a wireless network 420 such as a mobile communication network, a wireless LAN (WLAN), Wi-Fi, Bluetooth, and ZigBee, (420) or a combination thereof, depending on the installation environment. The method of communication is not limited, and may include a communication method using a communication network (e.g., mobile communication network, wired Internet, wireless Internet, broadcasting network, or satellite network) that may be included in the network 420 as well as short-range wireless communication between user terminals 410_1, 410_2, and 410_3. For example, the network 420 may include any one or more of networks including a personal area network (PAN), a local area network (LAN), a campus area network (CAN), a metropolitan area network (MAN), a wide area network (WAN), a broadband network (BBN), the Internet, and the like. In addition, the network 420 may include any one or more of network topologies including a bus network, a star network, a ring network, a mesh network, a star-bus network, a tree or hierarchical network, and the like, but not limited thereto.

In FIG. 4, a mobile phone or smart phone 410_1, a tablet computer 410_2, and a laptop or desktop computer 410_3 are illustrated as examples of user terminals, but example embodiments are not limited thereto, and the user terminals 410_1, 410_2, and 410_3 may be any computing device that is capable of wired and/or wireless communication and that allows a search application, a mobile browser application, or a web browser to be installed and executed. For example, the user terminal 410 may include a smart phone, a mobile phone, a navigation terminal, a desktop computer, a laptop computer, a digital broadcasting terminal, a personal digital assistant (PDA), a portable multimedia player (PMP), a tablet computer, a game console. a console, a wearable device, an internet of things (IoT) device, a virtual reality (VR) device, an augmented reality (AR) device, and so on. In addition, while FIG. 4 shows three user terminals 410_1, 410_2, and 410_3 communicate with the server 430 for providing trending search terms through the network 420, however, example embodiments are not limited thereto. In some example embodiments, a different number of user terminals 410_1, 410_2 and 410_3 may be configured to communicate with the server 430 for providing trending search terms through the network 420.

According to an example embodiment, the server 430 for providing trending search terms may receive one or more search terms input from the plurality of user terminals 410_1, 410_2, and 410_3. According to an example embodiment, the server 430 for providing trending search terms may receive search terms input into a search engine of a search site displayed by a web browser running on a plurality of desktop or laptop computers 410_3. According to another example embodiment, the server 430 for providing trending search terms may receive search terms input into a search engine of a search site displayed by a mobile browser application running on a plurality of mobile phones, smartphones, or tablet computers 410_1 and 410_2. The server 430 for providing trending search terms may determine search rankings (“first search ranking value”) of each corresponding search term based on the number of inputs of one or more search terms input from the plurality of user terminals 410_1, 410_2, and 410_3.

Further, the server 430 for providing trending search terms may be configured to receive weights of a plurality of categories and/or weight of the grouping from the user terminals 410_1, 410_2, and 410_3. According to an example embodiment, the server 430 for providing trending search terms may be configured to receive weights of a plurality of categories and/or groupings input by a user interface displayed on the user terminals 410_1, 410_2, and 410_3.

The server 430 for providing trending search terms may determine correlations of a plurality of categories with one or more search terms input from the plurality of user terminals 410_1, 410_2, and 410_3, and may apply weights of a plurality of categories received from the user terminals 410_1, 410_2, and 410_3 to the correlations of the plurality of categories to determine search rankings (“second search ranking value”) for each of the corresponding search terms. In addition, the server 430 for providing trending search terms may determine a final search ranking value based on the first search ranking value and the second search ranking value.

The server 430 for providing trending search terms may calculate the similarity between one or more search terms input from a plurality of user terminals 410_1, 410_2, and 410_3, and generate one or more groups including search terms whose calculated similarity is higher than the reference similarity. For example, when generating a group of search terms, the server 430 for providing trending search terms may adjust a reference similarity by applying a grouping weight to the reference similarity. Further, the server 430 for providing trending search terms may determine a group search ranking value based on the search rankings of search terms included in the generated groups.

The server 430 for providing trending search terms may transmit the first search ranking value, the second search ranking value, the final search ranking value, and/or the group search ranking value to the user terminals 410_1, 410_2, and 410_3 to output the same.

According to an example embodiment, each of the user terminals 410_1, 410_2, and 410_3 may receive the first search ranking value and the correlations of a plurality of categories with one or more search terms from the server 430 for providing trending search terms. Further, each of the user terminals 410_1, 410_2, and 410_3 may determine search rankings (“second search ranking value”) of each of the corresponding search terms by applying the received weights of the plurality of categories to the correlations of the plurality of categories. Further, each of the user terminals 410_1, 410_2, and 410_3 may determine final search ranking value based on the first search ranking value and the second search ranking value.

Each of the plurality of user terminals 410_1, 410_2, and 410_3 may receive similarities between one or more search terms and/or a group of one or more search terms from the server 430 for providing trending search terms. Further, each of the plurality of user terminals 410_1, 410_2, and 410_3 may adjust a reference similarity by applying a grouping weight to the reference similarity, and may generate one or more groups that include search terms with higher similarities between one or more search terms than the adjusted reference similarity. Further, each of the plurality of user terminals 410_1, 410_2, and 410_3 may determine a group search ranking value based on the search rankings of search terms included in the groups.

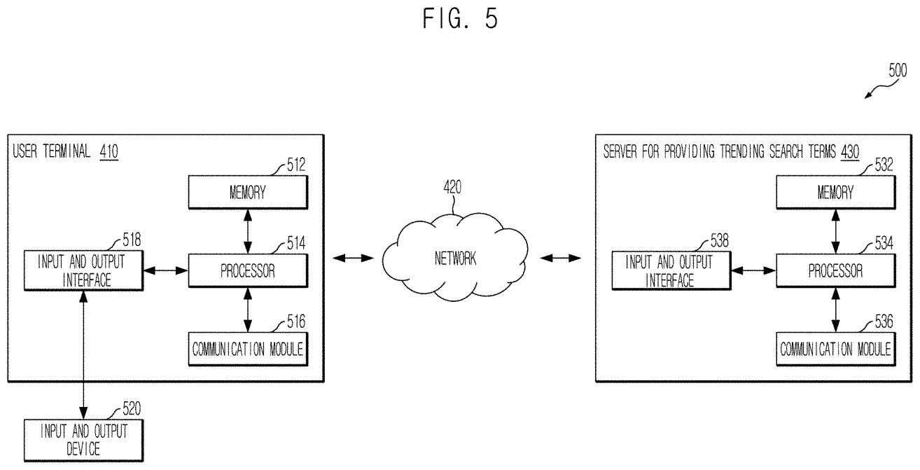

FIG. 5 is a block diagram 500 illustrating an internal configuration of the user terminal 410 and the server 430 for providing trending search terms according to an example embodiment.

The user terminal 410 may refer to any computing device that can execute a search application, a mobile browser application, or a web browser, and capable of wired/wireless communication, and the user terminal 410 may include a mobile phone or smart phone 410_1, a tablet computer 410_2, a laptop or desktop computer 410_3, and so on of FIG. 4, for example. As illustrated, the user terminal 410 may include a memory 512, a processor 514, a communication module 516, and an input and output interface 518. Similarly, the server 430 for providing trending search terms may include a memory 532, a processor 534, a communication module 536, and an input and output interface 538. As illustrated in FIG. 5, the user terminal 410 and the server 430 for providing trending search terms may be configured to communicate information and/or data through the network 420 using respective communication modules 516 and 536. In addition, the input and output device 520 may be configured to input information and/or data to the user terminal 410 or to output information and/or data generated from the user terminal 410 through the input and output interface 518.

The memories 512 and 532 may include any non-transitory computer-readable recording medium. According to an example embodiment, the memories 512 and 532 may include a permanent mass storage device such as random access memory (RAM), read only memory (ROM), disk drive, solid state drive (SSD), flash memory, and the like. As another example, a non-destructive mass storage device such as a ROM, SSD, flash memory, disk drive, and so on may be included in the user terminal 410 or the server 430 for providing trending search terms as a separate permanent storage device that is distinguished from the memory. In addition, the memories 512 and 532 may store an operating system and at least one program code (e.g., a code for search application, mobile browser application, or web browser) for providing trending search term providing service, which are installed and driven in the user terminal 410).

These software components may be loaded from a computer-readable recording medium separate from the memories 512 and 532. Such a separate computer-readable recording medium may include a recording medium directly connectable to the user terminal 410 and the server 430 for providing trending search terms, and may include a computer-readable recording medium such as a floppy drive, a disk, a tape, a DVD/CD-ROM drive, a memory card, and so on, for example. As another example, the software components may be loaded into the memories 512 and 532 through the communication modules rather than the computer-readable recording medium. For example, at least one program may be loaded into the memories 512 and 532 based on a computer program installed by files provided by developers or a file distribution system that distributes an installation file of an application through the network 420.

The processors 514 and 534 may be configured to process a command of a computer program by performing basic arithmetic, logic, and input and output operations. The command may be provided to the processors 514 and 534 from the memories 512 and 532 or the communication modules 516 and 536. For example, the processors 514 and 534 may be configured to execute the received command according to program code stored in a recording device such as memories 512 and 532.

The communication modules 516 and 536 may provide a configuration or function for the user terminal 410 and the server 430 for providing trending search terms to communicate with each other through the network 420, and may provide a configuration or function for the user terminal 410 and the server 430 for providing trending search terms to communicate with another user terminal or another system (e.g., a separate search engine system). As an example, control signals or commands provided under the control of the processor 514 of the user terminal 410 may be transmitted to the server 430 for providing trending search terms via the communication module 536 and the network 420. For example, the server 430 for providing trending search terms may receive information on one or more search terms, weights of a plurality of categories, and/or weight of the grouping from the user terminal 410. Conversely, the control signals or commands provided under the control of the processor 534 of the server 430 for providing trending search terms may be received by the user terminal 410 through the communication module 516 of the user terminal 410 via the communication module 536 and the network 420. For example, the user terminal 410 may receive the first search ranking value, the second search ranking value and/or the final search ranking value of one or more search terms, a category correlation value for one or more search terms, a similarity value between one or more search terms, or group information from the server 430 for providing trending search terms through the communication module 516.

The input and output interface 518 may be a means for interfacing with the input and output device 520. As an example, the input device may include a device such as a camera including an image sensor, a keyboard, a microphone, a mouse, and so on, and the output device may include a device such as a display, a speaker, a haptic feedback device, and so on. As another example, the input and output interface 518 may be a means for interfacing with a device such as a touch screen or the like that integrates a configuration or a function for performing inputting and outputting. For example, when the processor 514 of the user terminal 410 processes command of the computer program loaded in the memory 512, a service screen or search ranking configured using the information and/or data provided by the server 430 for providing trending search terms or other user terminals 410 may be displayed on the display through the input and output interface 518. While FIG. 5 illustrates that the input and output device 520 is not included in the user terminal 410, example embodiment is not limited thereto, and the input and output device 520 may be configured as one device with the user terminal 410. In addition, the input and output interface 538 of the server 430 for providing trending search terms may be a means for interfacing with a device (not shown) for inputting or outputting function which may be connected to, or included in the server 430 for providing trending search terms. In FIG. 5, the input and output interfaces 518 and 538 are illustrated as the components configured separately from the processors 514 and 534, but are not limited thereto, and the input and output interfaces 518 and 538 may be configured to be included in the processors 514 and 534.

The user terminal 410 and the server 430 for providing trending search terms may include more components than components of FIG. 5. Meanwhile, it would be unnecessary to illustrate all related components. According to an example embodiment, the user terminal 410 may be implemented to include at least some of the input and output devices 520 described above. In addition, the user terminal 410 may further include other components such as a transceiver, a global positioning system (GPS) module, a camera, various sensors, a database, and the like. For example, when the user terminal 410 is a smartphone, it may generally include components included in the smartphone, and for example, it may be implemented such that various components such as an acceleration sensor, a gyro sensor, a camera module, various physical buttons, buttons using a touch panel, input and output ports, a vibrator for vibration, and so on are further included in the user terminal 410.

According to an example embodiment, the processor 514 of the user terminal 410 may be configured to operate a search application, a mobile browser application, or a web browser capable of accessing a search or portal site for the service for providing trending search terms. In this case, a program code related with the application or web browser may be loaded into the memory 512 of the user terminal 410.

The processor 514 of the user terminal 410 may receive information and/or data provided from the input and output device 520 through the input and output interface 518 or receive information and/or data from the server 430 for providing trending search terms through the communication module 516, and process the received information and/or data and store it in the memory 512. In addition, such information and/or data may be provided to the server 430 for providing trending search terms through the communication module 516.

According to an example embodiment, the processor 514 may receive texts, images, actions, and so on, which may be input or selected through the input device 520 such as a touch screen, a keyboard, or the like connected to the input and output interface 518, and store the received texts, images and/or actions in the memory 512 or provide them to the server 430 for providing trending search terms through the communication module 516 and the network 420. For example, the processor 514 may receive inputs of one or more search terms, a plurality of categories, and/or weights of grouping through the input device such as a touch screen or a keyboard, and the received inputs of the received search term, a plurality of categories, and/or the weights of the grouping may be provided to the server 430 for providing trending search terms through the communication module 516 and the network 420.

The processor 514 of the user terminal 410 may be configured to manage, process, and/or store the information and/or data received from the input device 520, a plurality of other user terminals, the server 430 for providing trending search terms, and/or a plurality of external systems. The information and/or data processed by the processor 514 may be provided to the server 430 for providing trending search terms through the communication module 516 and the network 420.

According to an example embodiment, the processor 514 may detect a movement of at least one of a plurality of slide bars corresponding to the weights of a plurality of categories and/or groupings displayed on the user terminal 410, and determine the corresponding weights of a plurality of categories and/or grouping corresponding. The weights of a plurality of categories and/or groupings determined by the processor 514 may be provided to the server 430 for providing trending search terms through the communication module 516 and the network 420.

According to another example embodiment, the processor 514 may apply the weights of the plurality of categories received from the input device 520 to the correlations of the plurality of categories with one or more search terms, and determine the second search ranking value of each of the one or more search terms. For example, the processor 514 may analyze content related with one or more search terms received from the input device 520, and determine, based on the content analysis result, a plurality of category correlations based on a probability value that each of the one or more search terms will be included in each of the plurality of categories (e.g., a probability that each of the plurality of categories includes at least one of the one or more search terms), and may determine a second search ranking value of each of the one or more search terms by applying the weights of the plurality of categories to the determined correlations of the plurality of categories with respect to one or more search terms. The analyzing at the processor 514 regarding the content related with the search term may include analyzing one or more related keywords included in the document (e.g., web pages or electronic documents including multimedia data such as texts, images, or videos) searched by using the corresponding search term, and/or one or more other search terms related to the corresponding search term. As another example, the processor 514 may determine search terms included in a first search ranking range according to the first search ranking value, and determine the second search ranking value of the search terms included in the first search ranking range based on the weights of the plurality of categories and the correlations of the plurality of categories with the search terms included in the first search ranking range.

Further, the processor 514 may determine the final search ranking value of each of the one or more search terms based on the first search ranking value received from the server 430 for providing trending search terms through the communication module 516 and the network 420 and the determined second search ranking value.

According to still another example embodiment, the processor 514 may receive similarities between search terms from the server 430 for providing trending search terms through the communication module 516 and the network 420. The processor 514 generates a group that includes search terms having a higher similarity than the reference similarity corresponding to the weight of the grouping received from the input device 520, and may determine the group search ranking value based on the final search ranking values of the search terms included in one or more groups. For example, the processor 514 may determine a group search ranking value based on the highest ranking value among the final search ranking values of one or more search terms included in each of the one or more groups.

The processor 514 of the user terminal 410 may transmit the information and/or data to the input and output device 520 through the input and output interface 518 to output the same.

According to an example embodiment, the processor 514 may display, by a user interface, at least some of the one or more search terms according to the final search ranking value. For example, the processor 514 may display, by the user interface, at least some of the search terms included in the second search ranking range.

According to another example embodiment, the processor 514 may display, by the user interface, at least some of the one or more search terms according to the group search ranking value. For example, the processor 514 may arrange and display, by the user interface, one or more search terms included in each of the one or more groups according to the corresponding final search ranking value.

The processor 534 of the server 430 for providing trending search terms may be configured to manage, process, and/or store the information and/or data received from a plurality of user terminals including the user terminal 410 and/or a plurality of external systems. The information and/or data processed by the processor 534 may be provided to the user terminal 410 through the communication module 536 and the network 420.

According to an example embodiment, the processor 534 of the server 430 for providing trending search terms may determine the first search ranking value of each of the one or more search terms based on the number of inputs of one or more search terms provided from a plurality of user terminals 410 through the communication module 536 and the network 420. Further, the processor 534 may provide the determined first search ranking value of each of the one or more search terms to the user terminal 410 through the communication module 536 and the network 420.

According to another example embodiment, the processor 534 of the server 430 for providing trending search terms may receive a plurality of category weights and/or weights of grouping from the user terminal 410 through the communication module 536 and the network 420. For example, when a movement of at least one of a plurality of slide bars corresponding to the weights of a plurality of categories and/or groupings displayed on the user terminal 410 is detected, the processor 534 of the server 430 for providing trending search terms may receive the weights of a plurality of categories determined according to the movement of at least one slide bar detected from the user terminal 410 through the communication module 536 and the network 420.

According to still another example embodiment, the processor 534 may determine a plurality of category correlations with one or more search terms. For example, the processor 534 may analyze content related with one or more search terms, and determine, based on the analysis result, the correlations of the plurality of categories based on a probability value that each of the one or more search terms will be included in each of the plurality of categories (e.g., a probability that each of the plurality of categories includes at least one of the one or more search terms). The analyzing at the processor 534 regarding the content related with the search term may include analyzing one or more related keywords included in the document (e.g., web pages or electronic documents including multimedia data such as texts, images, or videos) searched by using the corresponding search term, and/or one or more other search terms related to the corresponding search term. As another example, the processor 534 may determine the correlations of a plurality of categories by an artificial neural network that is trained to infer a probability that one or more search terms will be included in each of the plurality of categories based on a search result for one or more search terms.

According to still another example embodiment, the processor 534 may determine the second search ranking value of each of the one or more search terms by applying the weights of the plurality of categories to the correlations of the plurality of categories with the one or more search terms. For example, the processor 534 may determine search terms included in the first search ranking range according to the first search ranking value, and determine the second search ranking value of the search terms included in the first search ranking range based on the weights of the plurality of categories and the correlations of the plurality of categories with the search terms included in the first search ranking range.

In addition, the processor 534 may determine the final search ranking value of each of the one or more search terms based on the first search ranking value and the second search ranking value.

According to still another example embodiment, the processor 534 of the server for providing trending search terms may calculate the similarity between one or more search terms, and the calculated similarity may be transmitted to the user terminal 410 through the communication module 536 and the network 420. For example, the processor 534 may calculate the similarity between search terms by calculating a distance between the search terms embedded in a vector space. The calculating the similarity between search terms at the processor 534 may include embedding one or more related keywords included in the document searched using a certain search term, and/or one or more other search terms related to the certain search term into a vector space, and then calculating a distance therebetween.

According to still another example embodiment, the processor 534 may generate one or more groups that include the search terms with a higher calculated similarity than the reference similarity. In addition, the processor 534 may allocate a group identifier (ID) to each group to identify the generated groups. In this case, the processor 534 may adjust the reference similarity by applying the grouping weight to the reference similarity. For example, the processor 534 may adjust the reference similarity value by multiplying the grouping weight by the reference similarity value. Further, the processor 534 may determine the group search ranking value based on the final search ranking values of the search terms included in one or more groups. For example, the processor 534 may determine a group search ranking value based on the highest ranking value among final search ranking values of one or more search terms included in each of the one or more groups.

The processor 534 of the server 430 for providing trending search terms may be configured to output the processed information and/or data through an output device such as a device (e.g. a touch screen or a display) capable of outputting a display of the user terminal 410 or a device (e.g., a speaker) capable of outputting an audio.

According to an example embodiment, the processor 534 of the server 430 for providing trending search terms may provide some of the search terms included in the first search ranking range to the user terminal 410 through the communication module 536 and the network 420, and the provided search term may be displayed on the user terminal 410 according to the final search ranking value. For example, in response to a call of the application programming interface (API) by the user terminal 410, the processor 534 may transmit, to the user terminal 410, information including the first search ranking value, a list of the search terms included in the first search ranking range, the second search ranking value and/or the final search ranking value. Accordingly, the user terminal 410 may display the final ranking value of the search term based on the received information through the device capable of outputting a display, or the like.

According to another example embodiment, the processor 534 of the server 430 for providing trending search terms may transmit at least some of the search terms included in one or more groups to the user terminal 410 according to the group search ranking value such that they are displayed on the user terminal 410. For example, in response to an API call by the user terminal 410, the processor 534 may transmit group information including an identifier of a search term group to the user terminal 410. Accordingly, the user terminal 410 may arrange and display one or more search terms included in each of the one or more groups according to the corresponding final search ranking values based on the received group information.

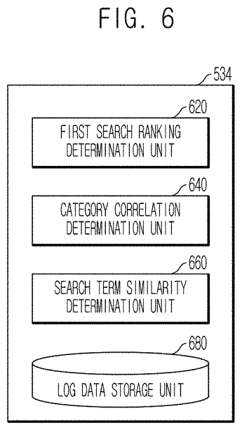

FIG. 6 is a block diagram illustrating an internal configuration of the processor 534 of the server for providing trending search terms according to an example embodiment.

The processor 534 of the server for providing trending search terms may include a first search priority determination unit 620, a category correlation determination unit 640, a search term similarity determination unit 660, and a log data storage unit 680.

The first search ranking determination unit 620 may determine the first search ranking value of each of the one or more search terms based on the number of inputs of one or more search terms, which are stored in the log data storage unit 680.

The category correlation determination unit 640 may determine category correlation of each search term. For example, the category correlation determination unit 640 may analyze content related with one or more search terms (e.g., multimedia contents such as texts, images, videos, or links to contents as a search result according to the search term), and may determine, based on the analysis result, the correlations of the plurality of categories based on a probability value that each of the one or more search terms will be included in each of the plurality of categories (e.g., a probability that each of the plurality of categories includes at least one of the one or more search terms). The analyzing at the category correlation determination unit 640 regarding the content related with the search term may include analyzing one or more related keywords included in the document (e.g., web pages or electronic documents including multimedia data such as texts, images, or videos) searched by using the corresponding search term, and/or one or more other search terms related to the corresponding search term. As another example, the category correlation determination unit 640 may determine the correlations of a plurality of categories by an artificial neural network that is trained to infer a probability that one or more search terms will be included in each of the plurality of categories based on a search result for one or more search terms.

The search term similarity determination unit 660 may calculate the similarity between one or more search terms stored in the log data storage unit 680. For example, the search term similarity determination unit 660 may calculate the similarity between search terms by calculating a distance between the search terms embedded in a vector space. The calculating the similarity between search terms at the search term similarity determination unit 660 may include embedding one or more related keywords included in the document searched using a certain search term, and/or one or more other search terms related to the certain search term into a vector space, and then calculating a distance therebetween.

The log data storage unit 680 may generate and store log data as history information of one or more search terms input from a plurality of user terminals and/or a search server. For example, the log data may be stored together with an input search term, the time when the search term is input, the number of times the search term is input, and information on a plurality of user terminals from which the search term is input.

While FIG. 6 illustrates that the processor 534 of the server for providing trending search terms may include the first search priority determination unit 620, the category correlation determination unit 640, the search term similarity determination unit 660, and the log data storage unit 680, example embodiments are not limited thereto. The processor 534 may include more components than the components shown in FIG. 6. For example, the processor 534 of the server for providing trending search terms may further include a component that determines the second search ranking value by applying the weights of a plurality of categories to the category correlation, a component that determines the final search ranking value based on the first search ranking value and the second search ranking value, and a component that applies the grouping weight to the reference similarity and generates a group of search terms based on the reference similarity and/or the like.

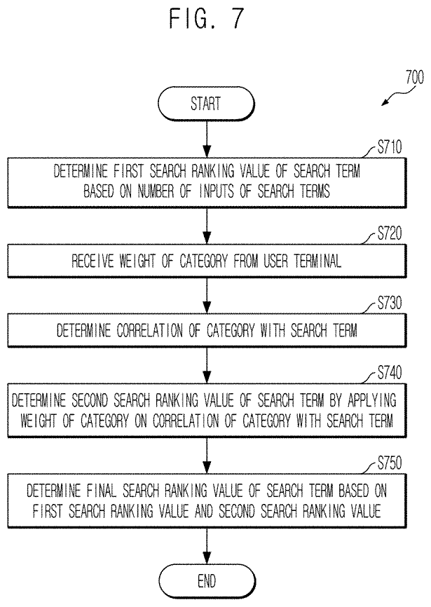

FIG. 7 is a flowchart illustrating a method 700 for determining a final search ranking value of a search term, which is performed by a server for providing trending search terms according to an example embodiment.

As illustrated, the method 700 for determining the final search ranking value of the search term, which is performed by the server for providing trending search terms, may begin at S710, by determining the first search ranking value of the search term based on the number of inputs of the search term.

Then, at S720, the weight of the category may be received from the user terminal. According to an example embodiment, the server for providing trending search terms may receive the weight of the category input from the user, by the user interface displayed on the user terminal. For example, when a movement of at least one of a plurality of slide bars corresponding to a plurality of categories displayed on the user terminal is detected, the server for providing trending search terms may determine the weights of the plurality of categories according to the detected movement of the at least one slide bar.

Next, at S730, the correlation of the category with the search term may be determined. According to an example embodiment, the server for providing trending search terms may analyze the content related with one or more search terms, and determine, based on the analysis result, the correlations of the plurality of categories with the one or more search terms based on the probability value that each of the one or more search terms will be included in each of the plurality of categories (e.g., the probability that each of the plurality of categories includes at least one of the one or more search terms). According to another example embodiment, the server for providing trending search terms may determine the correlations of a plurality of categories by an artificial neural network that is trained to infer the probability that one or more search terms will be included in each of the plurality of categories based on the search results for one or more search terms.

At S740, the second search ranking value of the search term may be determined by applying the weight of the category to the correlation of the category with the search term. According to an example embodiment, the server for providing trending search terms may determine the second search ranking value of the search terms included in the first search ranking range based on the weights of the plurality of categories and the correlations of the plurality of categories with the search terms included in the first search ranking range.

Finally, at S750, the final search ranking values of the search term may be determined based on the first search ranking value and the second search ranking value. According to an example embodiment, the server for providing trending search terms may determine the final search ranking value based on a result of summing the first and second search ranking values.

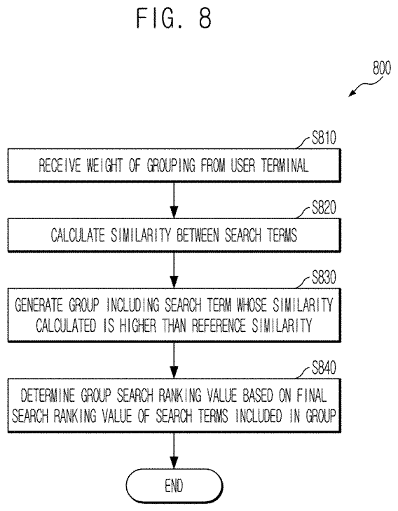

FIG. 8 is a flowchart illustrating a method 800 of determining the group search ranking value performed by the server for providing trending search terms according to an example embodiment.

As illustrated, the group search ranking value determination method 800 performed by the server for providing trending search terms may begin at S810, by receiving a weight of the grouping from the user terminal. According to an example embodiment, the server for providing trending search terms may receive the weight of the grouping input from the user, by a user interface displayed on the user terminal. For example, when the movement of the slide bar corresponding to the weight of the grouping (“issue group view” or the like) displayed on the user terminal is detected, the server for providing trending search terms may determine the weight of the grouping according to the detected movement of the slide bar.

Then, at S820, the similarity between search terms may be calculated. According to an example embodiment, the server for providing trending search terms may calculate the similarity between search terms by calculating a distance between the search terms embedded in a vector space. For example, the server for providing trending search terms may calculate the similarity or distance between the search terms in consideration of additional factors such as a keyword set, a related search term, and so on extracted from the content (e.g., multimedia content such as news, texts, images, or videos), which is a search result according to the search term.

Next, a group that includes a search term with a higher similarity calculated at S830 than the reference similarity may be generated. According to an example embodiment, the server for providing trending search terms may include, by grouping, the search terms with the higher calculated similarity than the reference similarity corresponding to the weight of the grouping received from the user terminal in the same group. According to another example embodiment, the server for providing trending search terms may include the search terms with a similarity to the search term corresponding to each ranking that is higher than the reference similarity in the same group, in a descending order from the search term ranked first based on the final search ranking value. When the search term of the corresponding rank is already included in the same group with a search term ranked higher than that, the server for providing trending search terms may perform grouping of the search term in the next order in the final search ranking without generating a separate group.

Finally, at S840, the group search ranking value may be determined based on the final search ranking value of the search terms included in the group. According to an example embodiment, the server for providing trending search terms may determine the group search ranking value based on a ranking value having a highest final search ranking value of one or more search terms included in each of the one or more groups.

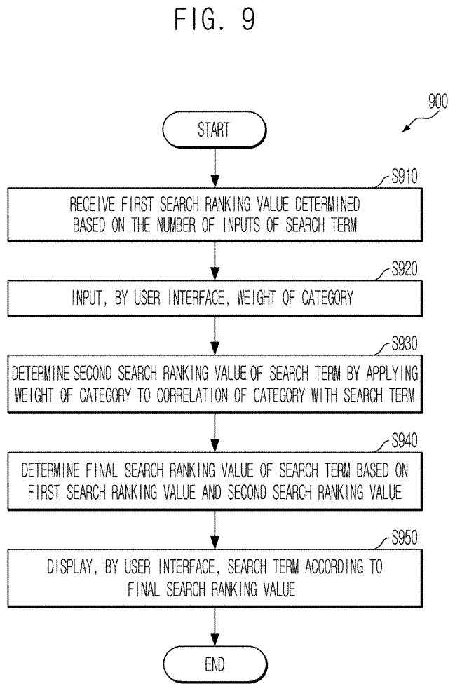

FIG. 9 is a flowchart illustrating a method 900 of determining the final search ranking value of the search term, which is performed by the user terminal according to an example embodiment.

As illustrated, the method 900 for determining the final search ranking value of the search term, which is performed by the user terminal, may begin at S910, by receiving the first search ranking value determined based on the number of inputs of the search terms. According to an example embodiment, the user terminal may receive, from the server for providing trending search terms, the first search ranking value of the search term determined by the server for providing trending search terms.

Then, at S920, the weight of the category may be input by the user interface. According to an example embodiment, the user terminal may receive, by the user interface, the weights of a plurality of categories. For example, the user terminal may detect a movement of at least one of a plurality of slide bars corresponding to a plurality of categories on the user interface, and determine weights of the plurality of categories according to the detected movement of the at least one slide bar.

Next, at S930, the second search ranking value of the search term may be determined by applying the weight of the category to the correlation of the category with the search term. According to an example embodiment, the user terminal may analyze the content related with one or more search terms, and determine, based on the analysis result, the correlations of the plurality of categories based on a probability value that each of the one or more search terms will be included in each of the plurality of categories (e.g., the probability that each of the plurality of categories includes at least one of the one or more search terms). The second search ranking value of each of the one or more search terms may be determined by applying the weights of the plurality of categories to the correlations of the plurality of categories with the one or more search terms determined in this way. According to another example embodiment, the user terminal may determine the second search ranking value of the search terms included in the first search ranking range based on the weights of the plurality of categories and the correlations of the plurality of categories with the search terms included in the first search ranking range

Next, at S940, the final search ranking value of the search term may be determined based on the first search ranking value and the second search ranking value. According to an example embodiment, the user terminal may determine the final search ranking value based on a result of summing the first and second search ranking values.

Finally, at S950, the search term may be displayed by the user interface according to the final search ranking value. According to an example embodiment, the user terminal may display, by the user interface, the corresponding search terms in a descending order down to a specific rank according to the final search ranking values.

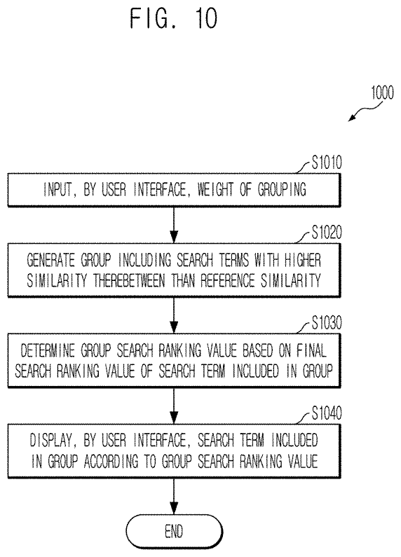

FIG. 10 is a flowchart illustrating a method 1000 for determining a group search ranking value, which is performed by a user terminal according to an example embodiment.

As illustrated, the method 1000 for determining a group search ranking value, which is performed by the user terminal, may begin at S1010, by receiving a weight of the grouping by the user interface.

Then, at S1020, a group that includes the search terms having a similarity therebetween that is higher than the reference similarity may be generated. According to an example embodiment, the user terminal may receive the similarity between the search terms from the server for providing trending search terms, and may include the search terms in the same group by grouping, when the search terms have the higher similarity than the reference similarity corresponding to the weight of the grouping input through the user interface. Here, the user terminal may detect the movement of the slide bar corresponding to the weight of the grouping on the user interface (e.g., a set value of ‘Group by Issue”), and determine the weight of the grouping determined according to the detected movement of the slide bar. According to another example embodiment, starting in order from the search term having the final search ranking value of the 1st rank, the search terms that have a higher similarity to the search term of the corresponding rank than the reference similarity may be included in the same group with the search term of the corresponding rank. When the search term of the corresponding rank is already included in the same group with the search term ranked higher than that, the user terminal may perform grouping of the search terms of the next rank without generating a separate group.

Next, at S1030, the group search ranking value may be determined based on the final search ranking value of the search terms included in the group. According to an example embodiment, the user terminal may determine the group search ranking value based on a ranking value having a highest final search ranking value of one or more search terms included in each of the one or more groups.

Finally, at S1040, the search terms included in the group may be displayed by the user interface according to the group search ranking value. According to an example embodiment, the user terminal may display, by the user interface, the corresponding search terms in a descending order down to a specific rank according to the group search ranking values.

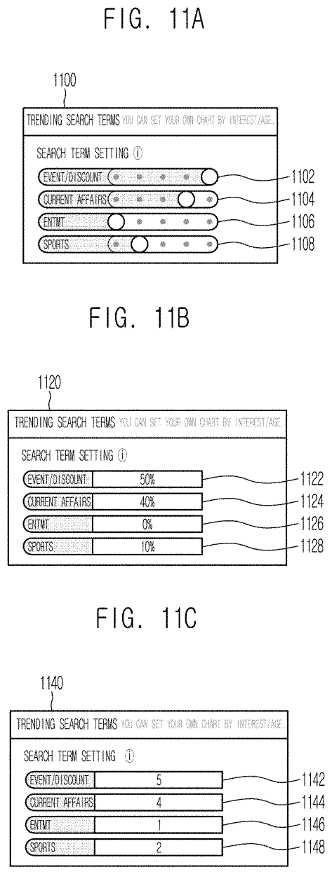

FIGS. 11A to 11C are example diagrams showing an operation of inputting weights of a plurality of categories according to an example embodiment.

As illustrated in FIG. 11A, a plurality of slide bars 1102, 1104, 1106, and 1108 corresponding to a plurality of categories may be displayed on a search term setting interface 1100 displayed on the user terminal. When the user selects and moves at least one of the slide bars 1102, 1104, 1106, and 1108 (e.g., according to an operation such as touch, drag, or click), the user terminal may detect the movement of the selected slide bar and determine weights of a plurality of categories according to a degree of the detected movement of the slide bar. In the illustrated example, it is shown that the user moves the slide bar 1102 of the “Event*Discount” category to level 5, the slide bar 1104 of the “Current Affairs” category to level 4, the slide bar 1106 of the “ENTMT” category to level 1, and the slide bar 1108 of the “Sports” category to level 2, respectively, to input the weight of the category.

Referring to FIG. 11B, input portions 1122, 1124, 1126, and 1128 for inputting weights of a plurality of categories in percent (%) units may be displayed on a search term setting interface 1120 displayed on the user terminal. When the user inputs a value into at least one of the input portions 1122, 1124, 1126, and 1128, the user terminal may determine the weights of a plurality of categories according to the input numerical value. In the illustrated example, it is shown that the user inputs 50% to the input portion 1122 of the “Event*Discount” category, 40% to the input portion 1124 of the “Current Affairs” category, 0% to the input portion 1126 of the “ENTMT” category, and 10% to the input portion 1128 of the “Sports” category. The user terminal may set such that the total sum of the percent values corresponding to weights of a plurality of categories displayed on the search term setting interface 1120 is automatically 100%.

Referring to FIG. 11C, input portions 1142, 1144, 1146, and 1148 for inputting weights of a plurality of categories in a certain range of numerical values may be displayed on a search term setting interface 1140 displayed on the user terminal. When the user inputs a value into at least one of the input portions 1142, 1144, 1146, and 1148, the user terminal may determine the weights of a plurality of categories according to the input numerical value. In the illustrated example, it is shown that the user inputs 5 to the input portion 1142 of the “Event*Discount” category, 4 to the input portion 1144 of the “Current Affairs” category, 1 to the input portion 1146 of the “ENTMT” category, and 2 to the input portion 1148 of the “Sports” category.

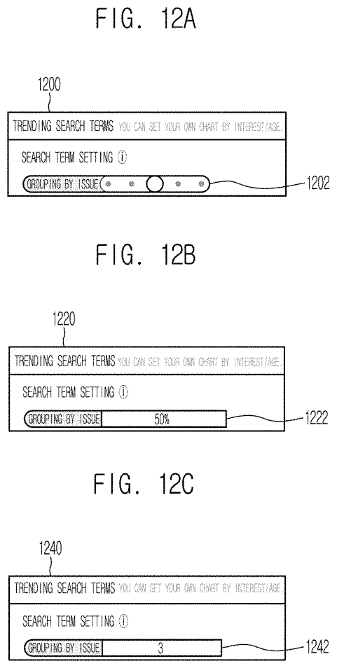

FIGS. 12A to 12C are example diagrams showing an operation of inputting a weight of the grouping according to an example embodiment.

Referring to FIG. 12A, a slide bar 1202 corresponding to the weight of the grouping may be displayed on a search term setting interface 1200 displayed on the user terminal. When the user selects and moves the slide bar 1202 (e.g., according to an operation such as touch, drag, or click), the user terminal may detect the movement of the selected slide bar and determine the weight of the grouping according to a degree of the detected movement of the slide bar.

As another alternative, in FIGS. 12B and 12C, input portions 1222 and 1242 for inputting a value (that is, a percentage (%) value or a numerical value) corresponding to the weight of the grouping may be displayed on search term setting interfaces 1220 and 1240 displayed on the user terminal. When the user inputs a numerical value into at least one of the input portions 1222 and 1242, the user terminal may determine the weight of the grouping according to the input value.

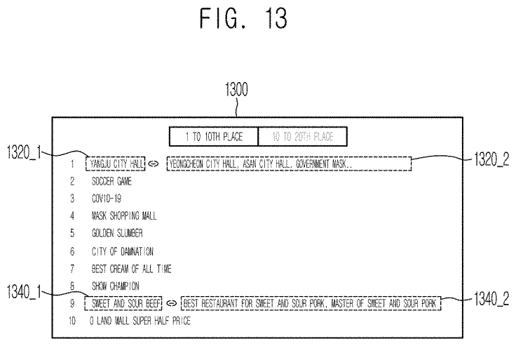

FIG. 13 is an example diagram showing an operation in which at least some of search terms included in one or more groups are displayed by the user interface or search ranking list 1300 according to the group search ranking value according to an example embodiment.

According to an example embodiment, the user terminal may arrange and output, on the search ranking list 1300, one or more search terms, which are included in each of the one or more groups according to the group search ranking value, according to the corresponding final search ranking values.

For example, among the search terms included in the group according to the group search ranking value, only the representative search term having the highest final search ranking value may be output together with the group search ranking value. That is, as illustrated, among the search terms included in the group whose group search ranking value corresponds to 1st rank, “Yangju City Hall” 1320_1, which is a search term having the highest final search ranking value may be output together with the group's ranking value “1”. Further, among the search terms included in the group whose group search ranking value corresponds to 9th rank, “Sweet and Sour Beef” 1340_1, which is a search term having the highest final search ranking value, may be output together with the group's ranking value “9”.

In another example, the search term with the highest final search ranking value among the search terms included in the group according to the group search ranking value may be output as the representative search term together with the group search ranking value, and next to the representative search term, some search terms included in the corresponding group are related to the representative search term may be output together. That is, as illustrated, “Yangju City Hall” 1320_1, which is the representative search term of the group whose group search ranking value corresponds to 1st rank, and “Yeongcheon City Hall, Asan City Hall, and so on” 1320_2, which are the related search terms included in the group, may be output together with the group search ranking value “1”. In addition, “Sweet and Sour Beef” 1340_1, which is the representative search term of the group whose group search ranking value corresponds to 9th rank, and “Best Restaurant For Sweet and Sour Pork, Master Of Sweet and Sour Pork” 1340_2, which are the related search terms included in the group, may be output with the group search ranking value “9”.

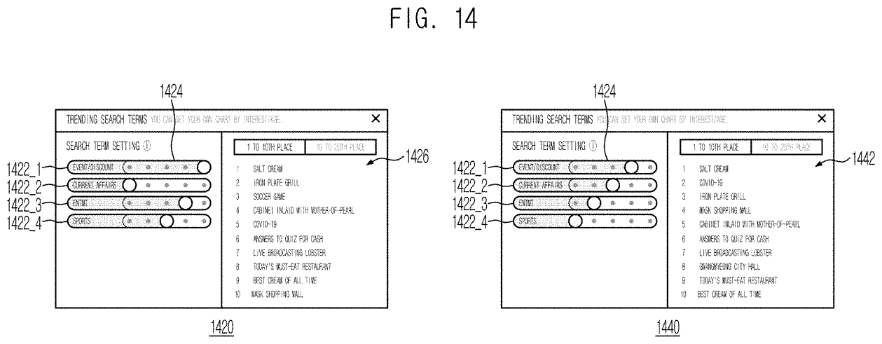

FIG. 14 is an example diagram showing an operation in which the search terms are output according to the final search ranking value determined based on the input weights of a plurality of categories according to an example embodiment.

According to an example embodiment, upon changing from a first state 1420 where a slide bar 1424 corresponding to a plurality of categories is set to a specific position to a second state 1440 where the slide bar is set to a different position, according to the movement of the corresponding slide bar 1424, the final search ranking value of search term may vary, and accordingly, the search terms output to the search ranking lists 1426 and 1442 may change.

For example, according to the states 1420 and 1440, the slide bar 1422_1 of the “Event*Discount” category may move from level 5 to level 4, the slide bar 1422_2 of the “Current Affairs” category may move from level 1 to level 3, the slide bar 1422_3 of the “ENTMT” category may move from level 4 to level 2, and the slide bar 1422_4 of the “Sports” category may move from level 3 to level 1. Accordingly, with the increased weight of the “Current Affairs” category, the search term “COVID-19”, which was ranked 5th in the search term ranking list 1426 output at the first state 1420 may now be ranked 2nd and output on the search term ranking list 1442 that is output at the second state 1440. Further, with the decreased weight of the “Sports” category, the search term “Soccer Game”, which was included in the search term ranking list 1426 output at the first state 1420, may not be included in the search term ranking list 1442 output at the second state 1440.

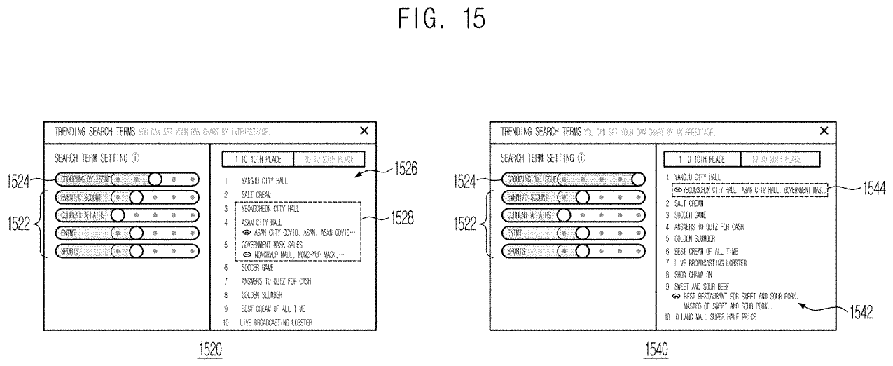

FIG. 15 is an example diagram showing an operation in which the search terms are output according to the group search ranking value determined based on the input weight of the grouping according to an example embodiment.

According to an example embodiment, upon changing from a first state 1520 to a second state 1540 such that a slide bar 1524 corresponding to the weight of the grouping is moved, it may change the groups generated as a result, the search terms included in each group, the group search ranking value, and the search terms to be output as a result.

For example, when the slide bar 1524 is moved to increase the weight of the grouping and thus decrease the reference similarity, the search terms with a lower similarity may be included in the same group by grouping. That is, as illustrated, with the weights 1522 of a plurality of categories maintained the same, when only the slide bar 1524 corresponding to the weight of the grouping is moved from level 3 to level 5, the search terms “Yeongcheon City Hall”, “Asan City Hall”, and “Government Mask Sales” 1544 included in the group 1528 whose group search ranking values corresponds to 3rd, 4th, and 5th ranks among the search term ranking list 1526 output at the state 1520, may be grouped into the same group with the search term “Yangju City Hall” whose the group search ranking value is 1st rank in the search term ranking list 1542 output at the state 1540.

According to some example embodiments of the present disclosure, a computer system (e.g., at least one processor included therein) may is configured to provide a simple interface for performing a method of providing improved search ranking information based on weights of a plurality of categories and/or a weight of grouping input by a user, while avoiding application of an implicit feedback to the search engine due to a reselection and input of top search terms by the users. Thus, the computer system according to some example embodiments may obtain the improved search ranking information without using significant additional computational resources and/or network resources.

The method for providing trending search terms described above may be implemented as a computer-readable code on a computer-readable recording medium. The recording medium may continuously store a program executable by a computer or may temporarily store a program for execution or download. Further, the medium may be a variety of recording means or storage means in a form in which a single piece of hardware or several pieces of hardware are combined. Such medium is not limited to a medium directly connected to any computer system, and may be present on a network in a distributed manner. Examples of media include magnetic media such as hard disks, floppy disks, and magnetic tape, optical media such as CD-ROMs and DVDs, magnetic-optical media such as floptical disks, a ROM, a RAM, a flash memory, and so on, and may be devices configured to store program instructions. In addition, examples of other media also include an app store that distributes applications, a site that supplies or distributes various software, and a recording medium or a storage medium managed by a server.

The methods, operations, or techniques of this disclosure may be implemented by various means. For example, these techniques may be implemented in hardware, firmware, software, or a combination thereof. Those skilled in the art will further appreciate that the various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. A general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The commands may be executable by one or more processors, and may cause the processor(s) to perform certain aspects of the functions described in the present disclosure.

When implemented in software, the techniques may be stored on a computer readable medium as one or more command or codes, or may be transmitted through a computer readable medium. The computer readable medium includes both the computer storage medium and the communication medium including any medium that facilitate the transfer of a computer program from one place to another. The storage media may also be any available media that may be accessed by a computer. By way of non-limiting example, such a computer readable medium may include RAM, ROM, EEPROM, CD-ROM or other optical disk storage, magnetic disk storage or other magnetic storage devices, or any other media that can be used to transfer or store desired program code in the form of instructions or data structures, and can be accessed by a computer. Further, a computer readable medium may refer to any connection configured to distribute the desired program code.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer readable media.

The software module may reside in, RAM memory, flash memory, ROM memory, EPROM memory, EEPROM memory, registers, hard disk, removable disk, CD-ROM, or any other form of storage medium known. An example storage medium may be connected to the processor, such that the processor may read or write information from or to the storage medium. In some example embodiments, the storage medium may be integrated into the processor. The processor and the storage medium may exist in the ASIC. The ASIC may exist in the user terminal. In some example embodiments, the processor and storage medium may exist as separate components in the user terminal.

Although the example embodiments described above have been described as utilizing aspects of the currently disclosed subject matter in one or more standalone computer systems, the present disclosure is not limited thereto, and may be implemented in conjunction with any computing environment, such as a network or distributed computing environment.

Furthermore, aspects of the subject matter in this disclosure may be implemented in multiple processing chips or devices, and storage may be similarly influenced across a plurality of devices. Such devices may include PCs, network servers, and portable devices.

Although the present disclosure has been described in connection with some example embodiments herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for providing trending search terms performed by at least one processor of a computer system, the method comprising:
determining first search ranking values of one or more search terms based on a number of inputs of the one or more search terms input from a plurality of first user terminals;
receiving weights of a plurality of categories from a second user terminal;
determining correlations of the plurality of categories with the one or more search terms;
determining second search ranking values of the one or more search terms by applying the weights of the plurality of categories to the correlations of the plurality of categories with the one or more search terms; and
determining final search ranking values of the one or more search terms based on the first search ranking values and the second search ranking values.

2. The method according to claim 1, wherein the determining the correlations of the plurality of categories to the one or more search terms includes:
analyzing a content related with the one or more search terms; and
determining, based on a result of the analyzing, the correlations of the plurality of categories based on a probability value that each of the plurality of categories includes at least one of the one or more search terms.

3. The method according to claim 1, wherein the determining the correlations of the plurality of categories to the one or more search terms includes:
determining the correlations of the plurality of categories by an artificial neural network that is trained to infer a probability that each of the plurality of categories includes at least one of the one or more search terms based on search results for the one or more search terms.

4. The method according to claim 1, wherein
the determining the first search ranking values of the one or more search terms further includes determining search terms included in a first search ranking range according to the first search ranking values, wherein
the determining the second search ranking values of the one or more search terms includes determining the second search ranking values of the search terms included in the first search ranking range based on the weights of the plurality of categories and the correlations of the plurality of categories with the search terms included in the first search ranking range.

5. The method according to claim 4, further comprising:
outputting at least some of the search terms included in the first search ranking range on the second user terminal.

6. The method according to claim 1, wherein the receiving the weights of the plurality of categories from the second user terminal includes:
detecting a movement of at least one of a plurality of slide bars corresponding to the plurality of categories displayed on the second user terminal; and
determining the weights of the plurality of categories according to the detected movement of the at least one of the slide bars.

7. The method according to claim 1, further comprising:
receiving a weight of a grouping from the second user terminal;
adjusting a reference similarity by applying the weight of the grouping to the reference similarity;
calculating a similarity between the one or more search terms;
generating one or more groups including search terms whose calculated similarity is higher than the reference similarity; and
determining a group search ranking value based on the final search ranking values of the search terms included in the one or more groups.

8. The method according to claim 7, wherein the determining the group search ranking value includes determining the group search ranking value based on a highest ranking value, among the final search ranking values of the one or more search terms, included in each of the one or more groups.

9. The method according to claim 7, further comprising:
outputting at least some of the search terms included in the one or more groups on the second user terminal according to the group search ranking value.

10. The method according to claim 9, wherein the outputting includes arranging and outputting the at least some of the search terms according to the final search ranking values corresponding thereto.

11. A method for providing trending search terms performed by at least one processor of a computer system, the method comprising:
receiving first search ranking values of one or more search terms determined based on a number of inputs of the one or more search terms input from a plurality of user terminals;
receiving, by a first user interface, weights of a plurality of categories;
determining second search ranking values of the one or more search terms by applying the weights of the plurality of categories to correlations of the plurality of categories with the one or more search terms;
determining final search ranking values of each of the one or more search terms based on the first search ranking values and the second search ranking values; and
displaying, by a second user interface, at least some of the one or more search terms according to the final search ranking values.

12. The method according to claim 11, further comprising:
analyzing a content related with the one or more search terms; and
determining, based on a result of the analyzing, the correlations of the plurality of categories based on a probability value that each of the plurality of categories includes at least one of the one or more search terms.

13. The method according to claim 11, further comprising:
determining search terms included in a first search ranking range according to the first search ranking values,
wherein the determining the second search ranking values of the one or more search terms includes determining the second search ranking values of the search terms included in the first search ranking range based on the weights of the plurality of categories and the correlations of the plurality of categories with the search terms included in the first search ranking range.

14. The method according to claim 13, wherein the displaying, by the second user interface, at least some of the one or more search terms according to the final search ranking values includes displaying at least some of the search terms included in the first search ranking range.

15. The method according to claim 11, wherein the receiving, by the first user interface, the weights of the plurality of categories includes:
detecting a movement of at least one of a plurality of slide bars corresponding to the plurality of categories on the first user interface; and
determining the weights of the plurality of categories according to the detected movement of the at least one of the slide bars.

16. The method according to claim 11, further comprising:
receiving, by a second user interface, a weight of a grouping;
generating one or more groups including search terms having a higher similarity to the one or more search terms than a reference similarity;
determining a group search ranking value based on the final search ranking values of the search terms included in the one or more groups; and
displaying, by the second user interface, at least some of the search terms included in the one or more groups according to the group search ranking value.

17. The method according to claim 16, wherein the determining the group search ranking value includes determining the group search ranking value based on a highest ranking value among the final search ranking values of the one or more search terms included in each of the one or more groups.

18. The method according to claim 16, wherein the displaying includes arranging and displaying the at least some of the search terms according to the final search ranking values corresponding thereto.

19. A system for providing trending search terms, comprising:
a memory; and
at least one processor connected to the memory and configured to execute computer-readable commands stored in the memory,
wherein the at least one processor is configured to,
receive one or more search terms from a plurality of user terminals and receive weights of a plurality of categories from a user terminal,
determine first search ranking values of the one or more search terms based on a number of inputs of the one or more search terms,
determine correlations of the plurality of categories with the one or more search terms,
determine second search ranking values of the one or more search terms by applying the weights of the plurality of categories to the correlations of the plurality of categories with the one or more search terms, and
determine final search ranking values of each of the one or more search terms based on the first search ranking values and the second search ranking values.

20. The system according to claim 19, wherein the at least one processor is further configured to,
receive a weight of a grouping from the user terminal,
adjust a reference similarity by applying the weight of the grouping to the reference similarity,
calculate a similarity between the one or more search terms,
generate one or more groups including search terms whose calculated similarity is higher than the reference similarity, and
determine a group search ranking value based on the final search ranking values of the search terms included in the one or more groups.
